(19) United States
(12) Patent Application Publication
(10) Pub. No.: US 2012/0009068 A1
(43) Pub. Date: Jan. 12, 2012

(54) LOW-HEAD ORTHOGONAL TURBINE

(76) Inventors: Yuliy Borisovitch Shpolianskiy, Moscow (RU); Boris Lvovitch Istorik, Moscow (RU)

(21) Appl. No.: 13/198,983

(22) Filed: Aug. 5, 2011

(30) Foreign Application Priority Data
Feb. 5, 2009 (RU) 2009103828
Feb. 5, 2009 (RU) PCT/RU2009/000748

(51) Int. Cl. F03D 3/06

(52) U.S. Cl. 416/197 A

(57) ABSTRACT

The invention relates to wind and hydraulic power engineering and can be used at tidal power plants, low-head river hydroelectric plants, wave power plants, and wind power plants to increase turbine efficiency by further reducing the relative power of idle jets in the flow chamber of an orthogonal turbine. The turbine comprises a rotor with wing-shaped profile blades mounted transversely in the flow chamber. The chamber has a transverse protrusion the upper face of which borders, with clearance, the surface of the cylinder defined by blades. In the cross-section perpendicular to the axis of the rotor, the side face of the transverse protrusion facing the inlet opening of the flow chamber is made concave, and tangent to this face forms an acute angle, with a straight line segment connecting the tangency point with the axis of the rotor, in the direction of the inlet opening of the flow chamber.

### CROSS-REFERENCE TO RELATED APPLICATION

This application claims the benefit of the priority filing date of international application no. PCT/RU2009/000748, and Russian application no. (RU) 2009103828 filed on Feb. 5, 2009.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The invention relates to wind and hydraulic power engineering, and can be used at tidal power plants (TPP), low-head river hydroelectric plants (HEPP), wave power plants, wind power plants with wind power concentrators, etc.

Low-head orthogonal turbines are reactive cross-jet turbines operating in a flow of liquid or gas inside a pressure flow chamber. A characteristic feature of an orthogonal turbine is that blades attached to the turbine rotor have a wing-shaped profile, and the flow of fluid around it creates a lift whose projection (tangential component) in the direction of the blade's circular movement provides the blade pull, wherein, in the operating mode, the blade's velocity is several times higher than the velocity of the incident flow. This feature makes it expedient to use orthogonal turbines in low-head flows. Another feature of these turbines is that during circular motion the blades are flown around by the fluid flow formed by the flow chamber in a non-stationary mode with the direction of the flow around the blade profile changing twice during each rotor rotation. As a result of this feature, the efficiency of an orthogonal turbine depends not only on the design of the rotor and blades, but also to a large extent on the configuration of the flow chamber. Herein, an important role is played by clearance δ between the surface of the cylinder described by the turbine blades and the surface of the flow chamber. To avoid water hammers in orthogonal turbines, it is necessary to make this clearance 10-20 times larger than in axial turbines.

Known is the orthogonal cross-jet turbine comprising a rotor with wing-shaped profile blades mounted transversely in the flow chamber that has inlet and outlet openings; in cross-sections perpendicular to the rotor axis, the flow chamber narrows linearly towards the rotor so that the flow chamber is smaller than its diameter D near the rotor. In the rotor rotation zone, the flow chamber widens along an arc of a circle with the diameter larger than the diameter D by the amount of clearance δ [1].

A disadvantage of the technical solution [1] is the low efficiency of the orthogonal turbine. According to Canadian researchers who conducted tests of a model of an orthogonal turbine with a similar flow chamber, the maximum efficiency of such turbine does not exceed 0.37[2].

Also known is the orthogonal turbine, selected as the prototype comprising a rotor with wing-shaped profile blades mounted transversely in the flow chamber having at least one protrusion with the upper face bordering (with clearance) the surface of the cylinder defined by the blades wherein in the cross-section perpendicular to the rotor axis, the upper face of the transverse protrusion is shifted with respect to the flow chamber transverse chamber by turning it at an acute central angle [3]. This solution [3] is used in several pilot industrial installations, the most powerful of which, has a 5 m diameter vertical orthogonal turbine that operates in the “Little Mezen TPP” floating model docked at the free water tunnel of the Kislogubskaya TPP [4]

The prototype turbine is more advanced: based on the results of full-scale tests conducted in 2007, the maximum efficiency of 0.64 was achieved. This level of efficiency makes the use of orthogonal turbines in TPP economically feasible compared to advanced, but much more expensive, axial Kaplan turbines of encapsulated units [5].

The prototype's disadvantage is as follows:

Due to the pressure differential between the flow chamber inlet and outlet openings, powerful idle jets form in the clearance δ, passing by the turbine blades without performing any effective work. The idle jets carry away a portion of energy of the flow fed to the turbine and flowing though its flow chamber and thus reduce the turbine's efficiency. Reducing clearance δ reduces the relative power of idle jets. However, it is impossible to make this clearance small based only on precision design considerations in turbine manufacturing, as is usually done for axial turbines. When clearance δ is reduced down to the design-permissible value, local high-pressure areas are formed in an orthogonal turbine, which results in water hammers when the blades pass over the flow chamber protrusions. Along with this, strong hydrodynamic noise is generated, blade loads increase sharply, and the turbine's efficiency is reduced. The value of clearance δ necessary to prevent water hammers that create destructive loads on blades can be as high as 0.02-0.04 of the diameter D of the orthogonal turbine, which is 10-20 times higher than for axial turbines.

The prototype has protrusions on the flow chamber walls that deflect the wall flow from getting directly into the clearance δ, which improves the distribution of overall power of the flow and thus increases turbine efficiency. However, the opportunities for deflecting the wall flow, and the accompanying increase of the orthogonal turbine efficiency are not fully utilized in the prototype

Disclosure of Invention. The objective of the invention is to increase turbine efficiency by further reducing the relative power of idle jets in the flow chamber of an orthogonal turbine.

The subject of the invention is a low-head orthogonal turbine comprising a rotor with wing-shaped profile blades mounted transversely in the flow chamber, having at least one protrusion with the upper face bordering (with clearance) the surface of the cylinder defined by the blades, wherein, in the cross-section perpendicular to the rotor axis, the side face of the transverse protrusion facing the inlet opening of the flow chamber is made concave, and at least one tangent to this face forms an acute angle in the direction of the inlet opening of the flow chamber with a straight line segment connecting the tangency point with the rotor axis.

The invention has subsequent developments which can be used in particular cases of its embodiment:
in the cross-section perpendicular to the rotor axis the straight line segment connecting the rotor axis with any point on the upper face of the transverse projection forms an acute angle with the transverse axis of the flow chamber in the direction of the rotor rotation;
in the cross-section, perpendicular to the rotor axis, the flow chamber is made maintaining the central symmetry about the rotor axis;
at least one jet-guiding component is installed in the flow chamber in front of the side face of the transverse protrusion facing the inlet opening of the flow chamber;
a fairing that self-aligns in the fluid flow is installed on the rotor capable of turning about the rotor axis;
the upper face of the protrusion is formed by the intersection of its side faces or by a common center with the rotor cylindrical surface of a cut crossing the side faces of the protrusion;
the blades are made straight with a wing-shaped profile that is constant along a blade length, and attached to the rotor parallel to its axis using disks or aerodynamically shaped brackets;
the blades' end faces are secured with disks or rings.

### SUMMARY

The invention relates to wind and hydraulic power engineering and can be used at tidal power plants, low-head river hydroelectric plants, wave power plants, and wind power plants with wind power concentrators. The turbine comprises a rotor 1 with wing-shaped profile blades 2 mounted transversely in the flow chamber 3. The chamber 3 has at least one transverse protrusion 6 the upper face 7 of which borders, with clearance, the surface of the cylinder defined by blades 2. In the cross-section perpendicular to the axis of the rotor 1, the side face of the transverse protrusion facing the inlet opening 4 of the flow chamber 3 is made concave, and at least one tangent to this face forms an acute angle, with a straight line segment connecting the tangency point with the axis of the rotor 1, in the direction of the inlet opening 4 of the flow chamber 3. The objective of the invention is to increase turbine efficiency by further reducing the relative power of idle jets in the flow chamber of an orthogonal turbine.

### DRAWINGS

FIG. 1 shows an example of the design of the claimed turbine for use in a unidirectional flow of fluid (typical, for instance, for a HEPP, or for a wind power plant with a predominance of a particular direction of wind).

FIG. 2 shows an example of the design of the claimed turbine for use in a unidirectional flow of fluid that changes its direction periodically (typical, for instance, for a TPP or a wave power plant).

FIGS. 3, 4 and 5 show three-dimensional views of possible embodiments of the orthogonal turbine rotor.

### DESCRIPTION

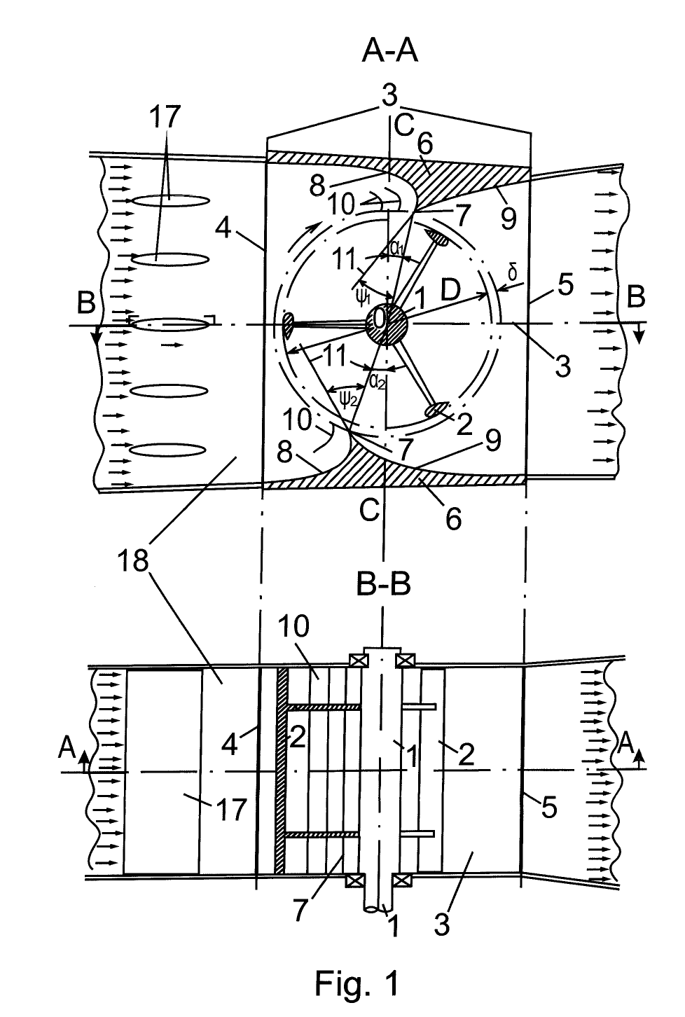

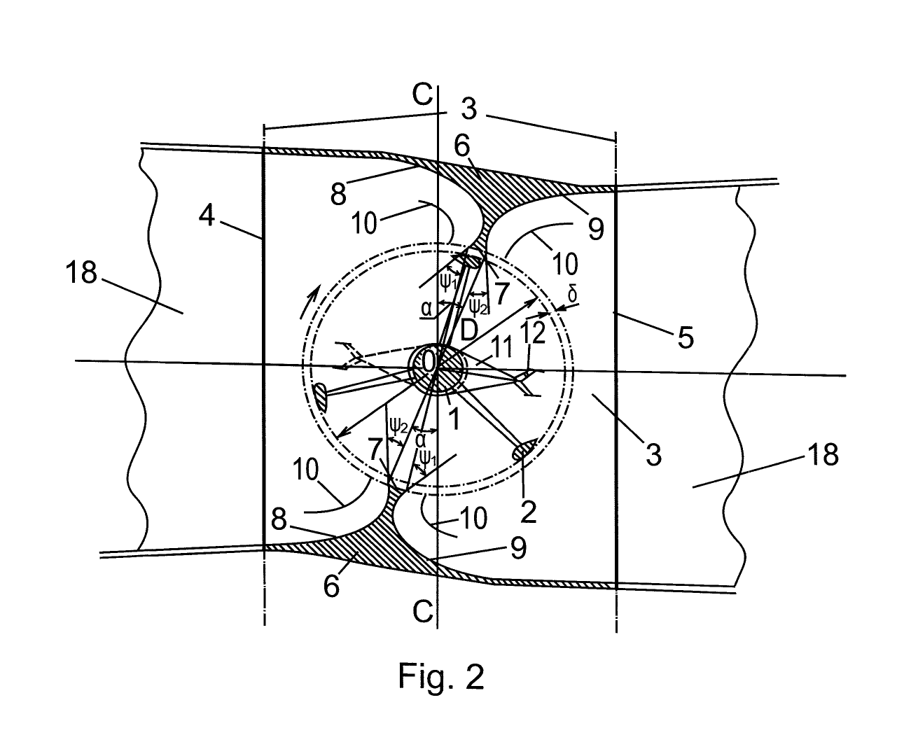

A low-head orthogonal turbine (see FIGS. 1 and 2) comprises a rotor 1 with wing-shaped profile blades 2 and a flow chamber 3. The rotor 1 is transversely mounted on bearings in the chamber 3. With this mounting of the rotor, its axis is located transversely to the flow of working fluid flowing through the end openings 4 and 5 of the chamber 3. The flow of working fluid rotating the rotor 1 can be a flow of liquid, for instance, water, or of gas, for instance, air. FIGS. 1 and 2 show one embodiment of the invention where there is one transverse protrusion 6 on each of the two opposite walls of the chamber 3. The protrusion 6 has an upper face 7 and side faces 8 and 9. The upper face 7 of the protrusion 6 borders, with the clearance δ, the surface of the diameter D cylinder described by the blades 2 during rotation of the rotor 1.

FIGS. 1 and 2 show the turbines' cross-sections perpendicular to the rotor 1 axis which is marked as point O. The longitudinal axis of the flow chamber 3 which is perpendicular to the planes of the holes 4 and 5 and the transverse axis C-C of the chamber 3 which is orthogonal to the longitudinal axis pass through point O. The side faces 8 of the protrusions 6 face the opening 4 and the side faces 9 face the opening 5 of the chamber 3.

In a turbine designed for use in a unidirectional flow of fluid (see FIG. 1), the opening 4 is designed for leading the flow to the rotor 1 and constitutes the inlet opening. In the cross-section shown, the faces 8 of the protrusions 6 facing this opening are made concave.

In a turbine designed for use in a flow of fluid that periodically changes its direction (see FIG. 2), each opening 4 and 5 is designed for leading the flow of fluid of the respective direction to the rotor 1, hence both of them are inlet openings. In this case, the side faces 8 facing the inlet opening 4 and the side faces 9 facing the inlet opening 5 are made concave in the cross-section shown.

One can also see in FIGS. 1 and 2 that in the cross-section shown on the concave face (face 8 in FIG. 1 and faces 8 and 9 in FIG. 2) of the protrusion 6, there is a point where the tangent to the face forms an acute angle ψ₁ or ψ₂ with the line segment connecting its tangent point with the axis of the rotor 1 in the direction of the respective inlet opening of the chamber 3.

In addition, one can see in FIGS. 1 and 2 that in the cross-section shown. the D/2+δ long line segment that connects the rotor axis O with the point on the upper face 7 of the transverse protrusion 6 forms an acute angle (α₁ or α₂ in FIG. 1 and a in FIG. 2) with the transverse axis C-C in the direction of rotation of the rotor 1. The direction of rotation of the rotor of an orthogonal turbine (the rotor rotates in the direction of the blunt leading edge of the wing-shaped profile of the blade 2) does not depend on the direction of fluid flow and is shown with an arrow in FIG. 1 and FIG. 2.

FIG. 1 shows one case where the upper face 7 of the protrusion 6 is formed by the line of intersection of its side faces 8 and 9, and FIG. 2 shows another case where the upper face 7 of the protrusion 6 is formed by a common center of the rotor 1 cylindrical surface of a cut crossing the side faces 8 and 9. In the latter case, the protrusions 6 have the shape of a “heel” in the cross-section shown.

In some embodiments of the invention, the angles α₁ or α₂ shown in FIG. 1 can be different. In this case, it is possible that one (only one) angle (α₁ or α₂) is negative, i.e., one of the protrusions 6 can be shifted from the transverse axis of the flow chamber along the circle with the diameter D+2δ in the direction opposite the direction of rotation of the rotor 1.

In the turbine shown in FIG. 2, the transverse protrusions 6 on the opposite walls of the turbine chamber are made maintaining central symmetry about the rotor axis (point O). In this case, the angle α is the same for both protrusions 6 in the same cross-section of the chamber 3.

It should be noted that in different cross-sections of the chamber 3 perpendicular to the rotor 1 axis, the angles α₁ or α₂ may not retain their values. Herein, the upper face 7 of the protrusion 6 is not be located parallel to the rotor axis, but is a curve or a broken line on the surface of a cylinder with the diameter D+2δ. This can make it possible to achieve gradualness tin order to avoid a water hammer) of passing of blades 2 over the upper face 7 of the protrusion 6 with a relatively small clearance 5.

FIGS. 1 and 2 also show jet-guiding components (deflectors) 10 installed next to the concave faces of the protrusions 6. FIG. 1 shows two deflectors by the upper protrusion and one deflector by the lower protrusion. FIG. 2 shows two deflectors 10 (one on each side of the protrusion 6) installed maintaining central symmetry. Between the concave face of the protrusion 6 and the nearest deflector 10 (see FIGS. 1 and 2), as well as between two adjacent deflectors 10 by the upper protrusion 6 (see FIG. 1), jet-guiding channels are formed which amplify the jet guiding effect of the side face of the protrusion 6.

FIG. 2 also shows a fairing 11 with a tail plane 12 which is installed on the rotor 1 and self-aligns in the fluid flow. The fairing is mounted in bearing supports, for instance, in sleeve bearings (not shown in FIG. 2). The solid line shows the position of the fairing 11 when fluid flows from left to right, and the dotted line shows its position when fluid flows in the opposite direction. The fairing 11 reduces head losses when fluid flow flows about the rotor 1 shaft, which provides additional increase of turbine efficiency.

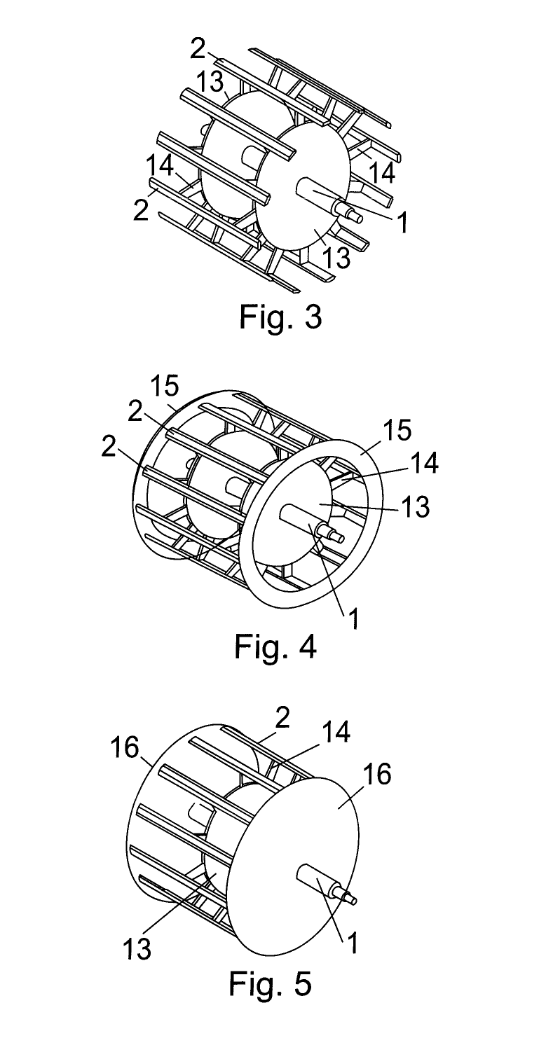

FIGS. 3, 4 and 5 show examples of simple and easy to manufacture designs of the rotor 1 with twelve straight blades 2 that have a constant wing-shaped profile along their lengths and are attached parallel to the rotor 1 axis.

FIG. 3 shows an example of attachment of blades 2 to the rotor 1 using two disks 13 and aerodynamically shaped radial brackets (spokes) 14.

FIGS. 4 and 5 show examples of the rotor 1 similar to the one shown in FIG. 3, wherein end faces of blades 2 are secured with rings 15 (FIG. 4) or disks 16 (FIG. 5).

The operation of the claimed turbine is described using the example of its use in a flow of water.

If there is a certain minimum head at the louver damper 17 that is installed, for instance, in the inlet pressure tunnel 18 (see FIG. 1; in FIG. 2 the damper is conditionally not shown), the damper 17 opens (the louvers turn and assume the position shown in FIG. 1). A flow that is transverse to the axis of the rotor 1 and to wing-shaped profile blades 2 flows through the chamber 3. The tangential component of the lift force acting on a blade 2 is directed along the tangent to the circle of diameter D described by the blades 2 of the rotor 1.

At any position of the rotor 1, for some blades 2 this is a pull force, and for some blades it is a brake force, i.e., it impedes the movement of the blade 2 towards its blunt leading edge. However, for a stationary rotor 1 the total moment of the pull force from all blades 2 is directed towards the blunt leading edge of the blade 2 profile. Therefore, if the service brake of the rotor 1 is released, the rotor starts rotation and self-acceleration. As the rotational speed of the rotor 1 and the speed of movement of blades 2 along a circumferential path increase, the moment of the pull force and the intensity of acceleration of the rotor 1 increase, first slowly and then rapidly. When a certain rotational speed of the rotor 1 is reached, the working load is turned on, for instance, by connecting to the network the generator the shaft of which is connected to the rotor 1. The rotor stops accelerating and switches to the working rotation mode.

The above-described shape of protrusions with the face curved inward and facing the inlet end opening of the chamber 3 makes it possible to optimize the angle of incidence of the flow approaching blades 2 by varying the parameter ψ in order to increase the rotor torque, while maintaining the positive direction of the pull force of its blades practically along the entire circumferential path of their movement, with the exception of only short sections of the path near the upper faces 7 of protrusions 6 where the direction of flow circulation around the blade changes rapidly and the value of the blade pull force passes through zero.

The direction of the tangent to the side face of the protrusion near its upper face towards the inward flow facilitates the redistribution of flow power from idle to working jets flowing around the turbine blades and thus facilitates an increase of turbine efficiency.

At TPP when the tidal wave direction changes the water head drops to zero. If, in this case, the turbine is brought to a stop, it can be turned back on only after the water head reaches the required minimum. To do this, when the head is zero and there is no water flow, the damper 17 is closed.

The use of the claimed orthogonal turbine at low-head HEPP and at TPP can be very cost effective. Based on the results of calculations that have been performed, the estimated increase of the efficiency of an orthogonal turbine due to the claimed technical solution is at least 5%. When applied to the Mezen TPP with rated capacity of 8000 MW, this results in an approximately 2 billion kWh higher electric power output compared to the prototype.

### INFORMATION SOURCES

1. Lyatkher, V. M. “A Set of Tidal Power Plants Supporting the Specified Power Output Schedule”, [symbol] [symbol] [symbol] [symbol] [Hydraulic Engineering], 1998, No. 12, p. 48, FIG. 8.
2. Fahre T. D., Pratte B. D. and Swan D. The Darrieus Hydraulic Turbine—Mode and Field Experiment. Fourth International Symposium on Hydro Power Fluid Machinery. Anaheim, Calif., December, 1986. American Society of Mechanical Engineers.
3. Patent RU2044155. A Hydraulic Engineering Installation. Istorik, B. L., and Shpolyanskiy, Yu. B., IPC FO3B 1/00, 1995.
4. Usachev, I. N., Shpolyanskiy, Yu. B., Istorik, B. L., Pastukhov, V. P., Kondratov Yu. V., Borodin, V. V., Savchenkov, S. N., and Kushnerik, V. I. “Erection of a Typical Floating Power Generating Unit for Tidal Power Plants”. [symbol] [symbol] [symbol] [symbol] [Hydraulic Engineering], 2007, No. 9, pp. 2-8.
5. Istorik, B. L., Prudovskiy, A. M., Usachev, I. N., and Shpolyanskiy, Yu. B., “The Use of an Orthogonal Turbine in Tidal Power Plants”. [symbol] [symbol] [symbol] [symbol] [Hydraulic Engineering], 1988, No. 12, p. 35.

What is claimed:

1. A low-head orthogonal turbine comprising a rotor with wing-shaped profile blades mounted transversely in the flow chamber having at least one protrusion with the upper face bordering, with clearance, the surface of the cylinder defined by the blades, wherein, in the cross-section perpendicular to the rotor axis, the side face of the transverse protrusion facing the inlet opening of the flow chamber is made concave, and at least one tangent to this face forms an acute angle, with a straight line segment connecting the tangency point with a rotor axis, in the direction of the inlet opening of the flow chamber.

2. The turbine according to claim 1, distinct in that, in the cross-section perpendicular to the rotor axis, the straight line segment connecting the rotor axis with any point on the upper face of the transverse projection forms an acute angle with a transverse axis of the flow chamber in the direction of rotor rotation.

3. The turbine according to claim 1, distinct in that, in the cross-section perpendicular to the rotor axis, the flow chamber is made maintaining the central symmetry about the rotor axis.

4. The turbine according to claim 1, distinct in that at least one jet-guiding component is installed in the flow chamber in front of the side face of the transverse protrusion facing the inlet opening of the flow chamber.

5. The turbine according to claim 1, distinct in that a fairing that self-aligns in the fluid flow is installed on the rotor capable of turning about the rotor axis.

6. The turbine according to claim 1, distinct in that the upper face of the protrusion is formed by intersection of its side faces.

7. The turbine according to claim 1, distinct in that the upper face of the protrusion is formed by a common center with the rotor cylindrical surface of a cut crossing the side faces of the protrusion.

8. The turbine according to claim 1, distinct in that the blades are made straight, with a wing-shaped profile that is constant along a blade length, and attached to the rotor parallel to its axis.

9. The turbine according to claim 8, distinct in that the blades are attached to the rotor using disks or aerodynamically shaped brackets.

10. The turbine according to claim 8, distinct in that the blades' end faces are secured with disks or rings.
